(19) United States
(12) Patent Application Publication
(10) Pub. No.: US 2019/0185619 A1
(43) Pub. Date: Jun. 20, 2019

(54) POLYESTER-BASED POLYMERS HAVING IMPROVED HYDROLYTIC STABILITY

(71) Applicant: SABIC GLOBAL TECHNOLOGIES B.V., Bergen Op Zoom (NL)

(72) Inventors: Yuzhen Yang, Evansville (IN); Husnu Alp Alidedeoglu, Newburgh, IN (US); Manojkumar Chellamuthu, Newburgh, IN (US)

(73) Assignee: SABIC GLOBAL TECHNOLOGIES B.V., Bergen Op Zoom (NL)

(21) Appl. No.: 16/301,066

(22) PCT Filed: May 1, 2017
(86) PCT No.: PCT/EP2017/060310

§ 371 Date: Nov. 13, 2018

(30) Foreign Application Priority Data
May 13, 2016 (EP) 16169507.7

(51) Int. Cl. C08G 63/91; C08G 63/183; C08L 67/03; C08K 7/14; C08K 5/1515

(52) U.S. Cl. CPC C08G 63/916; C08G 63/183; C08L 67/03; C08L 23/06; C08K 5/1515; C08L 2207/066; C08K 7/14

(57) ABSTRACT

The present invention relates to a polymer obtainable by reaction of a polyester comprising a quantity of carboxylic terminal groups with a chain extending compound wherein the chain extending compound is selected from an aromatic bis(oxirane ether) or an aromatic bis(methyloxirane ether). Such polymer may have a desired resistance to hydrolytic degradation.

The present invention relates to polymers having improved hydrolytic stability. The invention further relates to a process for the production of such polymers. The invention also relates to articles produced using such polymers.

Polymers such as polyesters, in particular thermoplastic polyesters, including such as poly(ethylene terephthalate) and poly(butylene terephthalate), are well-known products that have a wide field of application, including in the production of electronic equipment, household appliances, lighting systems, as well as in automotive parts for interior, exterior and under-the bonnet applications. Polyesters may be shaped into the desired products via a wide variety of shaping techniques, such as via melt extrusion, fibre spinning, blow moulding and injection moulding.

Polyesters possess a number of properties that render them particularly suitable for the above mentioned areas of application and shaping techniques. Amongst others, polyesters have a desirable dimensional stability of moulded parts, have desirable mechanical and electrical properties, and may be shaped into the desired parts in rapid, high yield production processes.

However, for certain applications, there is a need to improve the hydrolytic stability, also referred to as the resistance of polyesters to hydrolytic degradation. For example, where the polyesters are exposed to severe environmental conditions including high temperature and humidity exposure, a high hydrolytic stability is required. This is for example the case in automotive exterior and under-the-bonnet applications.

A factor influencing the hydrolytic stability of polyesters is the quantity of carboxylic end groups present in the polyesters. A higher carboxylic end group content may have a negative effect on the hydrolytic stability of the polyester, i.e. may lead to increased hydrolytic degradation.

In order to reduce the hydrolytic degradation, various developments have been considered. For example, WO2014131701A1 discloses the use of compounds comprising at least one epoxy moiety and a least one alkoxysilane moiety to improve the hydrolytic stability of polyesters. However, the improvement presented is insufficient for many applications.

Accordingly, there is an existing need for the development of polymers having a desired degree of resistance to hydrolytic degradation. This has now been achieved by a polymer obtainable by reaction of a polyester comprising a quantity of carboxylic terminal groups with a chain extending compound wherein the chain extending compound is selected from an aromatic bis(oxirane ether) or an aromatic bis(methyloxirane ether).

Such polymer may have a desired resistance to hydrolytic degradation, for example demonstrated by the retention of material properties including the melt volume flow rate, the tensile strength, and/or the Izod impact strength upon exposure to a certain high temperature and humidity for a certain time, such as upon exposure to a temperature of 80° C. at 70% relative humidity for 250 hours or 500 hours.

In the context of the present invention, the melt volume flow rate may be determined according to ISO 1133-1 (2011); the tensile strength may be determined according to ISO527-1 (2012); the Izod impact strength may be determined according to ISO 180 (2000).

Carboxylic terminal groups in the context of the present invention may for example be terminal groups of a polyester polymer having a structure:

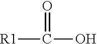

Wherein R1 represents the polymer chain.

It is believed that the oxirane ether and methyloxirane ether groups in the chain extending compound react with the carboxylic terminal groups to form a moiety comprising a hydroxyl group that may react during the exposure of the polymer to conditions occurring during use or storage of the polymer, such as by exposure to outdoor conditions and weather conditions, with carboxylic groups occurring in its vicinity, thereby preventing structural degradation of the polymer, and thus contributing to retention of material properties.

The polyesters used in the preparation of the polymer of the present invention may for example be reaction products of a reaction mixture comprising diols and dicarboxylic acids or the diesters of such dicarboxylic acids. Such diols may for example be aliphatic diols, such as ethylene glycol, propylene glycol, 1,4-butanediol, or combinations thereof. The dicarboxylic acids or the diesters thereof may for example be aromatic dicarboxylic acids or the diesters thereof. Examples of such aromatic dicarboxylic acids are terephthalic acid, isophthalic acid and naphthalene dicarboxylic acid. Examples of diesters of such aromatic dicarboxylic acids are dimethyl terephthalate, diethyl terephthalate, dimethyl isophthalate and diethyl isophthalate.

In the production of the polyesters that may be used in the preparation of the polymer according to the present invention, combinations of such aromatic dicarboxylic acids or diesters thereof may be used. The polyester used in the preparation of the polymer of the present invention may be a homopolyester or a copolyester. The polyester may for example be a linear polyester or a block copolymer.

The polyester used in the production of the polymer according to the present invention may for example be selected from poly(ethylene terephthalate), poly(propylene terephthalate), poly(ethylene naphthanoate), or poly(butylene terephthalate). Preferably, the polyester is poly(butylene terephthalate).

In a particular embodiment, the polyester used in the production of the polymer according to the present invention is a poly(butylene terephthalate) or a poly(ethylene terephthalate) homopolymer. Alternatively, the polyester may be a poly(butylene terephthalate) or a poly(ethylene terephthalate) copolymer comprising ≤5 wt % of units derived from a dicarboxylic acid or diester thereof that is not terephthalic acid or a diester thereof. For example, the polyester may be a poly(butylene terephthalate) or a poly(ethylene terephthalate) copolymer comprising ≤5 wt % of units derived from a dicarboxylic acid selected from isophthalic acid, napthalenic acid, 1,2-cyclohexane dicarboxylic acid, 1,4-cyclohexane dicarboxylic acid, 1,4-butane dicarboxylic acid, 1,6-hexane dicarboxylic acid, 1,8-octane dicarboxylic acid, 1,10-decane dicarboxylic acid, or combinations thereof.

The polyester may be a polyester comprising units according to formula I:

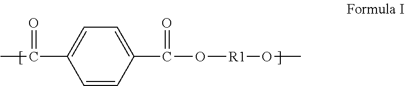

wherein R1 is selected from CH₂—CH₂, CH₂—CH₂—CH₂, or CH₂—CH₂—CH₂—CH₂.

More preferably, the polyester is a polyester comprising units according to formula II:

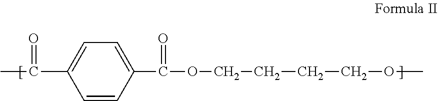

The polyester may for example have a carboxylic end group content as determined in accordance with ASTM D7409-15 of ≥5 and ≤100 mmol/g, more preferably ≥5 and ≤50 mmol/g, or ≥10 and ≤30 mmol/g. In particular, the polyester may be a poly(ethylene terephthalate), poly(propylene terephthalate), poly(ethylene naphthanoate), or poly(butylene terephthalate), having a carboxylic end group content of ≥5 and ≤100 mmol/g, more preferably ≥5 and ≤50 mmol/g, or ≥10 and ≤30 mmol/g. The polyester may have an intrinsic viscosity of ≥0.50 and ≤2.00 dl/g as determined in accordance with ASTM D2857-95 (2007), more preferably ≥0.50 and ≤1.50 dl/g, or ≥1.00 and ≤1.50 dl/g. In particular, the polyester may be a poly(ethylene terephthalate), poly(propylene terephthalate), poly(ethylene naphthanoate), or poly(butylene terephthalate), having an intrinsic viscosity of ≥0.50 and ≤2.00 dl/g, more preferably ≥0.50 and ≤1.50 dl/g, or ≥1.00 and ≤1.50 dl/g. For example, the polyester may be a poly(ethylene terephthalate), poly(propylene terephthalate), poly(ethylene naphthanoate), or poly(butylene terephthalate), having an intrinsic viscosity of ≥0.50 and ≤2.00 dl/g, more preferably ≥0.50 and ≤1.50 dl/g, or ≥1.00 and ≤1.50 dl/g and having a carboxylic end group content of ≥5 and ≤100 mmol/g, more preferably ≥5 and ≤50 mmol/g, or ≥10 and ≤30 mmol/g. In an embodiment of the invention, the polyester is a poly(ethylene terephthalate) or a poly(butylene terephthalate) having an intrinsic viscosity of 0.50 and ≤1.50 dl/g and a carboxylic end group content of ≥5 and ≤50 mmol/g.

Such polyester is particularly desirable because of its rate of crystallization, which makes it particularly suitable for injection moulding. In addition, such polyester has a high degree of crystallinity, which results in desirable chemical resistance.

The polyester may for example be poly(butylene terephthalate), wherein the poly(butylene terephthalate) has:
a carboxylic end group content as determined in accordance with determined in accordance with ASTM D7409-15 of ≥5 and ≤100 mmol/g; and/or
an intrinsic viscosity of ≥0.50 and ≤2.00 dl/g as determined in accordance with ASTM D2857-95 (2007).

The chain extending compound preferably is selected from 2,2′-methylene-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bis(3-methyl-oxirane), 4,4′-bis(1,2-epoxypropoxy)biphenyl, 2,2′-((1,1′-biphenyl])-4,4′-diylbis(oxy))bisoxirane, 1,4-bis(1,2-epoxypropoxy)benzene, 2,2′-(1,4-phenylenebis(oxy)bisoxirane, 2,2′-((1,1′-binaphthalene)-2,2′-diylbis(oxy))bisoxirane, ((6′-oxiranylmethoxy(2,2′-binaphthalene)-6-yl)oxy)oxirane, 2,2′-(1,6-naphthalenediylbis(oxy))bisoxirane, 2,2′-((1,1′-biphenyl)-4,4′-diylbis(oxy))bis(2-methyl-oxirane), 2,2′-(2,6-naphthalenediylbis(oxy))bis(2-methyl-oxirane), 2,2′-(methylenebis(4,1-phenyleneoxy))bis(2-methyl-oxirane), 2,2′-(1,4-phenylenebis(oxy))bis(2-methyl-oxirane), (2-methyl-4-((oxiranyloxy)methyl)phenoxy)oxirane, or (2,6-dimethyl-4-((oxiranyloxy)methyl)phenoxy)oxirane. Alternatively, the chain extending compound is selected from combinations thereof. In a preferred embodiment, the chain extending compound is 2,2′-(1-methylethylidene)-bis(4,1-phenyleneoxy)bisoxirane.

It is preferred that the chain extending compound is added in a quantity of ≥0.5 and ≤8.0 wt % with regard to the total weight of the polyester to the reaction of the polyester and the chain extending compound, more preferably ≥1.0 and ≤5.0 wt %, even more preferably ≥1.0 and ≤3.0 wt %, or ≥1.5 and ≤2.5 wt %.

The polymer according to the present invention may preferably comprise units according to formula III:

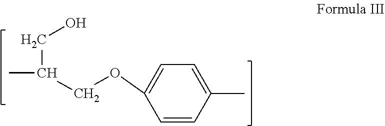

For example, the polymer may comprise units according to formula I and ≥0.03 mol of units according to formula III per mol of units according to formula I. Alternatively, the polymer may comprise units according to formula I and ≥0.05 mol of units according to formula III per mol of units according to formula I. The polymer may comprise units according to formula I and ≤0.25 mol of units according to formula III per mol of units according to formula I, alternatively ≤0.20 mol, alternatively ≤0.15 mol.

Preferably, the polymer comprises unit according to formula I and ≥0.03 mol and ≤0.25 mol of units according to formula III per mol of units according to formula I, alternatively ≥0.05 mol and ≤0.15 mol of units according to formula III per mol of units according to formula I.

More preferably, the polymer may comprise units according to formula II and ≥0.03 mol of units according to formula III per mol of units according to formula II. Alternatively, the polymer may comprise units according to formula II and ≥0.05 mol of units according to formula III per mol of units according to formula II. The polymer may comprise units according to formula II and ≤0.25 mol of units according to formula III per mol of units according to formula II, alternatively ≤0.20 mol, alternatively ≤0.15 mol.

Preferably, the polymer comprises unit according to formula II and ≥0.03 mol and ≤0.25 mol of units according to formula III per mol of units according to formula II, alternatively ≥0.05 mol and ≤0.15 mol of units according to formula III per mol of units according to formula II.

The presence of such quantity of units according to formula III is believed to contribute to the retention of material properties including the melt volume flow rate, the tensile strength, and the Izod impact strength upon exposure to a certain high temperature and humidity for a certain time, such as upon exposure to a temperature of 80° C. at 70% relative humidity for 250 hours or 500 hours.

It is particularly preferred that the polymer according to the present invention is produced using a poly(butylene terephthalate) comprising units according to formula II, and that the polymer comprises ≥0.03 mol and ≤0.25 mol of units according to formula III per mol of units according to formula II, alternatively ≥0.05 mol and ≤0.15 mol of units according to formula III per mol of units according to formula II.

The quantity of units of formula I, II and III in the polymer may for example be determined using NMR.

The polymer according to the present invention may for example have a complex viscosity as determined via dynamic mechanical spectroscopy (DMS) at 1 rad/s of ≥1200 Pa·s, more preferably ≥1500 Pa·s, alternatively ≥2000 Pa·s or ≥2500 Pa·s.

Such complex viscosity is an indicator for a certain degree of crosslinking, which contributes to improved hydrostability and chemical resistance.

The polymer according to the present invention may be produced by the reaction of a polyester comprising a quantity of carboxylic terminal groups with a chain extending compound wherein the chain extending compound is selected from an aromatic bis(oxirane ether) or an aromatic bis(methyloxirane ether), wherein the reaction takes place in the presence of a catalyst. The catalyst may for example be one selected from:
an oxide selected from zinc oxide, magnesium oxide, titanium oxide, or antimony trioxide;
a borate selected from zinc borate, calcium borate, sodium tetraphenylborate, tetrabutyl ammonium tetraphenylborate, trioctanol borate or triethanol borate;
a phosphate selected from zinc phosphate, calcium phenyl phosphate, calcium hydroxyapatite, aluminium phosphate, or zinc diethylphosphinate; or
a carboxylate selected from sodium acetate, zinc acetate, magnesium stearate, calcium stearate, sodium stearate or zinc stearate.

In a preferred embodiment, the catalyst is a carboxylate selected from sodium acetate, zinc acetate, magnesium stearate, calcium stearate, sodium stearate or zinc stearate. The catalyst may for example be present in a quantity of ≥0.01 and ≤0.25 wt %, alternatively ≤ 0.03 and ≤0.20 wt %, alternatively ≥0.05 and ≤0.15 wt %, with regard to the total weight of the polyester and the chain extending compound.

In a further preferred embodiment, the present invention relates to a polymer obtained by reaction of a polyester comprising a quantity of carboxylic terminal groups with a chain extending compound wherein the chain extending compound is an aromatic bis(oxirane ether), wherein the chain extending compound is added in a quantity of ≥1.0 and ≤3.0 wt % with regard to the total weight of the polyester to the reaction of the polyester and the chain extending compound, wherein the polyester is selected from poly(ethylene terephthalate), poly(propylene terephthalate), poly(ethylene naphthanoate), or poly(butylene terephthalate), and wherein the polyester has an intrinsic viscosity of 0.50-1.5 dl/g as determined in accordance with ASTM D2857-95 (2007).

It is particularly preferred that the polymer according to the present invention is obtained by reaction of a polyester comprising a quantity of carboxylic terminal groups with a chain extending compound wherein the chain extending compound is an aromatic bis(oxirane ether), wherein the chain extending compound is added in a quantity of ≥1.0 and ≤3.0 wt % with regard to the total weight of the polyester to the reaction of the polyester and the chain extending compound, wherein the polyester is selected from poly(ethylene terephthalate), poly(propylene terephthalate), poly(ethylene naphthanoate), or poly(butylene terephthalate), and wherein the polyester has an intrinsic viscosity of 0.50-1.5 dl/g as determined in accordance with ASTM D2857-95 (2007), and that the polymer comprises units according to formula I:

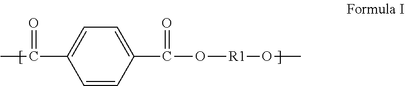

wherein R1 is CH₂—CH₂—CH₂—CH₂;

and

≥0.03 and ≤0.25 mol of units according to formula III:

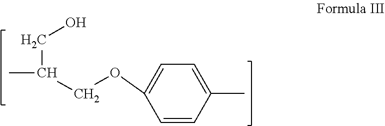

per mol of units according to formula I.

The polymer according to the present invention may be produced by subjecting the polyester and the chain extender to melt mixing in a melt extruder, the melt extruder comprising one or more extruder screws each having a tip and one or more openings for removing the polymer from the extruder, the melt extruder further also comprising a volume of space between the tip(s) of the screw(s) and the opening(s), wherein the temperature in the volume of space in the area between the tip(s) of the extruder screw(s) and the opening(s) for removing the obtained polymer composition is 250-260° C. The residence time of the polyester in the melt extruder may for example be 15-45 seconds.

In a further embodiment, the invention also relates to a polymer composition comprising the polymer according to the invention, wherein the polymer composition further comprises:
5.0-40.0 wt % of glass fibres; and/or
0.0-10.0 wt % of polyethylene

with regard to the total weight of the polymer composition.

It is preferred that the polymer composition comprises 5.0-30.0 wt % of glass fibres, alternatively 5.0-25.0 wt %, or 10.0-20.0 wt %, with regard to the total weight of the polymer composition.

It is preferred that the polyethylene is selected from a low-density polyethylene, a linear low-density polyethylene, or a high-density polyethylene. For example, the polyethylene may be a linear low-density polyethylene having a density of ≥910 and ≤930 kg/m³, alternatively ≥916 and ≤925 kg/m³ as determined in accordance with ISO 1183-1 (2012).

It is preferred that the polymer composition comprises 1.0-8.0 wt % of polyethylene, alternatively 2.0-8.0 wt %, alternatively 4.0-7.0 wt %, with regard to the total weight of the polymer composition.

The polymer composition in a preferred embodiment comprises the polymer according to the invention, and further comprises:
5.0-40.0 wt % of glass fibres; and/or
1.0-8.0 wt % of polyethylene;

wherein the polyethylene is a linear low-density polyethylene having a density ≥916 and ≤930 kg/m³.

It is preferred that the polymer composition comprises ≥50.0 and ≤90.0 wt % of the polymer according to the invention, alternatively ≥60.0 and ≤80.0 wt %, with regard to the total weight of the polymer composition. For example, the polymer composition may comprise 50.0-90.0 wt % of the polymer according to the invention, 5.0-40.0 wt % of glass fibres, and 1.0-8.0 wt % of linear low-density polyethylene having a density ≥916 and ≤925 kg/m³.

In particular, the polymer composition may comprise 50.0-90.0 wt % of a polymer obtained by reaction of a polyester comprising a quantity of carboxylic terminal groups with a chain extending compound wherein the chain extending compound is an aromatic bis(oxirane ether), wherein the chain extending compound is added in a quantity of ≥1.0 and ≤3.0 wt % with regard to the total weight of the polyester to the reaction of the polyester and the chain extending compound, wherein the polyester is selected from poly(ethylene terephthalate), poly(propylene terephthalate), poly(ethylene naphthanoate), or poly(butylene terephthalate); 5.0-40.0 wt % of glass fibres; and 1.0-8.0 wt % of linear low-density polyethylene having a density ≥916 and ≤930 kg/m³.

In a particular embodiment, the invention relates to a polymer obtainable by reaction of a polyester comprising a quantity of carboxylic terminal groups with a chain extending compound wherein the chain extending compound is selected from an aromatic bis(oxirane ether) or an aromatic bis(methyloxirane ether);

wherein the polyester is poly(butylene terephthalate), wherein the poly(butylene terephthalate) has:
a carboxylic end group content as determined in accordance with ASTM D7409-15 of ≥5 and ≤100 mmol/g; and/or
an intrinsic viscosity of ≥0.50 and ≤2.00 dl/g as determined in accordance with ASTM D2857-95 (2007);

and

wherein the chain extending compound is used in a quantity of ≥0.5 and ≤8.0 wt % with regard to the total weight of the polyester in the reaction of the polyester and the chain extending compound.

In a further particular embodiment, the invention relates to a polymer obtainable by reaction of a polyester comprising a quantity of carboxylic terminal groups with a chain extending compound wherein the chain extending compound is selected from an aromatic bis(oxirane ether) or an aromatic bis(methyloxirane ether);

wherein the polyester is poly(butylene terephthalate), wherein the poly(butylene terephthalate) has:
a carboxylic end group content as determined in accordance with ASTM D7409-15 of ≥5 and ≤100 mmol/g; and/or
an intrinsic viscosity of ≥0.50 and ≤1.50 dl/g as determined in accordance with ASTM D2857-95 (2007);

and

wherein the chain extending compound is used in a quantity of ≥1.5 and ≤5.0 wt %, preferably ≥2.0 and ≤4.0 wt %, with regard to the total weight of the polyester in the reaction of the polyester and the chain extending compound.

In a further particular embodiment, the invention relates to a polymer obtainable by reaction of a polyester comprising a quantity of carboxylic terminal groups with a chain extending compound wherein the chain extending compound is selected from an aromatic bis(oxirane ether) or an aromatic bis(methyloxirane ether);

wherein the polyester is poly(butylene terephthalate), wherein the poly(butylene terephthalate) has:
a carboxylic end group content as determined in accordance with ASTM D7409-15 of ≥10 and ≤50 mmol/g; and/or
an intrinsic viscosity of ≥0.50 and ≤1.50 dl/g as determined in accordance with ASTM D2857-95 (2007);

and

wherein the chain extending compound is used in a quantity of ≥1.5 and ≤5.0 wt %, preferably ≥2.0 and ≤4.0 wt %, with regard to the total weight of the polyester in the reaction of the polyester and the chain extending compound.

In yet a further particular embodiment, the invention relates to a polymer obtainable by reaction of a polyester comprising a quantity of carboxylic terminal groups with a chain extending compound wherein the chain extending compound is 2,2′-(1-methylethylidene)-bis(4,1-phenyleneoxy)bisoxirane;

wherein the polyester is poly(butylene terephthalate), wherein the poly(butylene terephthalate) has:
a carboxylic end group content as determined in accordance with ASTM D7409-15 of ≥10 and ≤50 mmol/g; and/or
an intrinsic viscosity of ≥0.50 and ≤1.50 dl/g as determined in accordance with ASTM D2857-95 (2007);

and

wherein the chain extending compound is used in a quantity of ≥1.5 and ≤5.0 wt %, preferably ≥2.0 and ≤4.0 wt %, with regard to the total weight of the polyester in the reaction of the polyester and the chain extending compound.

In another further embodiment, the invention relates to a polymer composition comprising a polymer obtainable by reaction of a polyester comprising a quantity of carboxylic terminal groups with a chain extending compound wherein the chain extending compound is 2,2′-(1-methylethylidene)-bis(4,1-phenyleneoxy)bisoxirane;

wherein the polyester is poly(butylene terephthalate), wherein the poly(butylene terephthalate) has:
a carboxylic end group content as determined in accordance with ASTM D7409-15 of ≥10 and ≤50 mmol/g; and/or
an intrinsic viscosity of ≥0.50 and ≤1.50 dl/g as determined in accordance with ASTM D2857-95 (2007);

wherein the chain extending compound is used in a quantity of ≥1.5 and ≤5.0 wt %, preferably ≥2.0 and ≤4.0 wt %, with regard to the total weight of the polyester in the reaction of the polyester and the chain extending compound; and

wherein the polymer composition further comprises:
5.0-40.0 wt % of glass fibres; and/or
0.0-10.0 wt % of linear low-density polyethylene having a density of ≥905 and ≤930 kg/m³ as determined in accordance with ISO 1183-1 (2012)

with regard to the total weight of the polymer composition.

Further in yet another embodiment, the invention relates to a polymer composition comprising a polymer obtainable by reaction of a polyester comprising a quantity of carboxylic terminal groups with a chain extending compound wherein the chain extending compound is 2,2′-(1-methylethylidene)-bis(4,1-phenyleneoxy)bisoxirane;

wherein the polyester is poly(butylene terephthalate), wherein the poly(butylene terephthalate) has:
a carboxylic end group content as determined in accordance with ASTM D7409-15 of ≥10 and ≤50 mmol/g; and/or
an intrinsic viscosity of ≥0.50 and ≤1.50 dl/g as determined in accordance with ASTM D2857-95 (2007);

wherein the chain extending compound is used in a quantity of ≥1.5 and ≤5.0 wt %, preferably ≥2.0 and ≤4.0 wt %, with regard to the total weight of the polyester in the reaction of the polyester and the chain extending compound; and

wherein the polymer composition further comprises:
5.0-40.0 wt % of glass fibres; and/or
3.0-10.0 wt % of linear low-density polyethylene having a density of ≥905 and ≤930 kg/m³ as determined in accordance with ISO 1183-1 (2012)

with regard to the total weight of the polymer composition.

The invention will now be illustrated by the following non-limiting examples.

For the preparation of samples illustrating the present invention, the materials as listed in table 1 were used.

TABLE 1
Materials used in preparation of exemplary samples

| | |
|---|---|
| Valox 195 | Poly(butylene terephthalate) obtainable from SABIC |
| | having a carboxylic end group content as determined |
| | in accordance with ASTM D7409-15 of 17 mmol/g and |
| | an intrinsic viscosity of 0.57 dl/g as determined |
| | in accordance with ASTM D2857-95 (2007), and a number |
| | average molecular weight Mn of 17.5 kg/mol. |
| Valox 315 | Poly(butylene terephthalate) obtainable from SABIC |
| | having a carboxylic end group content as determined |
| | in accordance with ASTM D7409-15 of 38 mmol/g and |
| | an intrinsic viscosity of 1.20 dl/g as determined |
| | in accordance with ASTM D2857-95 (2007), and a number |
| | average molecular weight Mn of 36.5 kg/mol. |
| Cycloepoxy | (3,4-Epoxycyclohexyl)methyl 3,4-epoxycyclo- |
| | hexylcarboxylate, CAS registry nr. 2386-87-0 |
| BPA epoxy | 2,2′-(1-methylethylidene)-bis(4,1-phenyleneoxy)bisoxirane, |
| | CAS registry nr. 1675-54-3 |
| GF | Glass fibre |
| Stab | Hindered phenol stabilizer, pentaerythritol-tetrakis(3-(3,5- |
| | di-tert-butyl-4-hydroxyphenyl) propionate), CAS registry |
| | nr. 6683-19-8 |
| Cat | Sodium stearate, CAS registry nr. 822-16-2 |
| LLDPE | Linear low density polyethylene of grade DNDA-8320NT7 |
| | from Ravago |

In an Entek 27 mm melt extruder, polymer compositions were produced according to the material formulations as listed in table 2:

TABLE 2
Material formulations of exemplary samples

| | Example | | | | | |
|---|---|---|---|---|---|---|
| | 1 | 2 | 3 | 4 (C) | 5 (C) | 6 (C) |
| Valox 315 | 20.00 | 20.00 | 20.00 | 20.00 | 20.00 | 20.00 |
| Valox 195 | 44.06 | 43.21 | 41.51 | 44.06 | 43.21 | 41.51 |
| Cycloepoxy | | | | 0.85 | 1.70 | 3.40 |
| BPA epoxy | 0.85 | 1.70 | 3.40 | | | |
| GF | 30.00 | 30.00 | 30.00 | 30.00 | 30.00 | 30.00 |
| Stab | 0.04 | 0.04 | 0.04 | 0.04 | 0.04 | 0.04 |
| Cat | 0.05 | 0.05 | 0.05 | 0.05 | 0.05 | 0.05 |
| LLDPE | 5.00 | 5.00 | 5.00 | 5.00 | 5.00 | 5.00 |

The values presented in table 2 indicate parts by weight.

The material formulations of examples 1-3 reflect the present invention. The material formulations of examples 4-6 are included for comparative purposes.

Of the polymers compositions produced according to the material formulations of table 2, material properties were determined. For certain properties, the values were determined after the preparation of the samples, as well as after 250 hours and/or 500 hours of exposure to a temperature of 80° C. at 70% relative humidity. The results are presented in table 3.

TABLE 3
Material properties of exemplary polymer compositions

| | Example | | | | | |
|---|---|---|---|---|---|---|
| | 1 | 2 | 3 | 4 (C) | 5 (C) | 6 (C) |
| MVR | 34.1 | 38.3. | 31.4 | 35.0 | 52.0 | 65.0 |
| MVR₂₅₀ | 31.2 | 29.1 | 32.6 | 54.0 | 73.0 | 85.0 |
| ΔMVR₂₅₀ | −8.5 | −24.0 | +3.8 | +53.0 | +40.0 | +31.0 |
| MVR₅₀₀ | 46.0 | 38.2 | 32.5 | 166.0 | 101.0 | 75.0 |
| ΔMVR₅₀₀ | +34.9 | −0.3 | +3.5 | +373 | +94 | +15 |
| TM | 9042 | 9098 | 9250 | 9336 | 8930 | 8286 |
| TM₂₅₀ | 9063 | 9133 | 9197 | 9277 | 9033 | 8423 |
| ΔTM₂₅₀ | +0.2 | +0.4 | −0.6 | −0.6 | +1.2 | +1.7 |
| TM₅₀₀ | 9200 | 9270 | 9360 | 9393 | 9123 | 8667 |
| ΔTM₅₀₀ | +1.7 | +1.9 | +1.2 | +0.6 | +2.2 | +4.6 |
| TS | 123 | 127 | 131 | 122 | 121 | 113 |
| TS₂₅₀ | 126 | 130 | 131 | 124 | 126 | 121 |
| ΔTS₂₅₀ | +2.4 | +2.4 | 0.0 | +1.6 | +4.1 | +7.1 |
| TS₅₀₀ | 124 | 130 | 128 | 123 | 122 | 115 |
| ΔTS₅₀₀ | +0.8 | +2.4 | −2.3 | +0.8 | +0.8 | +1.8 |
| Izod | 103 | 102 | 101 | 93.2 | 88.8 | 85.5 |
| Izod₂₅₀ | 90.8 | 94.5 | 88.6 | 80.6 | 78.5 | 74.8 |
| ΔIzod₂₅₀ | −11.9 | −7.3 | −12.2 | −13.5 | −11.6 | −12.6 |
| Izod₅₀₀ | 88.1 | 96.8 | 88.1 | 80.8 | 74.1 | 70.8 |
| ΔIzod₅₀₀ | −14.5 | −5.1 | −12.8 | −13.3 | −16.6 | −17.2 |
| CV | 2350 | 3800 | 1570 | 1030 | 1080 | 480 |

Wherein:

MVR is the melt volume flow rate as determined in accordance with ISO 1133-1 (2011) at 250° C. under a load of 5 kg, expressed in cm³/10 min. MVR was determined upon preparation of the samples. MVR₂₅₀ is the melt volume flow rate determined after 250 hours of exposure as indicated above. MVR₅₀₀ is the melt volume flow rate after 500 hours of exposure. ΔMVR₂₅₀ is the change in melt volume flow rate between the MVR and the MVR₂₅₀, expressed in %. ΔMVR₅₀₀ is the change in melt volume flow rate between the MVR and the MVR₅₀₀, expressed in %.

TM is the tensile modulus as determined in accordance with ISO 527-1 (2012), expressed in MPa. TM was determined upon preparation of the samples. TM₂₅₀ is the tensile modulus after 250 hours of exposure. TM₅₀₀ is the tensile modulus after 500 hours of exposure. ΔTM₂₅₀ is the change in tensile modulus between the TM and the TM₂₅₀, expressed in %. ΔTM₅₀₀ is the change in tensile modulus between the TM and the TM₅₀₀, expressed in %.

TS is the tensile strength at yield as determined in accordance with ISO 527-1 (2012), expressed in MPa. TS was determined after preparation of the samples. TS₂₅₀ is the tensile strength after 250 hours of exposure. TS₅₀₀ is the tensile strength after 500 hours of exposure. ΔTS₂₅₀ is the change in tensile strength between the TS and the TS₂₅₀, expressed in %. ΔTS₅₀₀ is the change in tensile modulus between the TS and the TS₅₀₀, expressed in %.

Izod is the notched Izod impact strength as determined in accordance with ISO 180 (2000), notch type A, at 23° C., expressed in J/m. Izod was determined upon preparation of the samples. Izod₂₅₀ is the Izod impact strength after 250 hours of exposure. Izod₅₀₀ is the Izod impact strength after 500 hours of exposure. ΔIzod₂₅₀ is the change in Izod impact strength between Izod and Izod₂₅₀. ΔIzod₅₀₀ is the change in Izod impact strength between Izod and Izod₅₀₀.

CV is the complex viscosity as determined via DMS at an angular frequency of 1 rad/s, expressed in Pa·s. For determining the DMS spectrum, an ARES G2 rheometer was used at 200° C. measuring at frequencies of 0.01 rad/s to 100 rad/s, at a linear viscoelastic strain of 5%, using plates of 0.5 mm thickness produced according to ISO 1872-2 (2007).

From the above presented examples, it becomes apparent that polymers according to the present invention have reduced tendency to degrade when subjected to exposure to a certain high temperature and humidity for a certain time, such as upon exposure to a temperature of 80° C. at 70% relative humidity for 250 hours or 500 hours.

The experiments demonstrate that the tensile strength of the polymer compositions is maintained for each of the examples. The ΔTS₂₅₀ and the ΔTS₅₀₀ are for each of the examples close to of even above 0, indicating no loss of tensile strength during the exposure period. In absolute terms, the tensile strength of the examples according to the invention is higher than of the comparative examples.

This is also the case for the Izod impact strength. Comparing each of the experimental pairs 1 and 4, 2 and 5, and 3 and 6, shows that the Izod impact strength of the examples according to the invention is higher than of the comparative examples. With respect to retention of Izod impact strength after a given period of exposure, the examples according to the invention demonstrate at least an equal level of retention, which means that even after exposure, the Izod impact strength of the examples according to the invention is still higher than of the comparative examples.

Furthermore, in particular in the case of example 2, which represents an example of a polymer obtained by reaction of a polyester comprising a quantity of carboxylic terminating groups with a chain extending compound wherein the chain extending compound is selected from an aromatic bis(oxirane ether) or an aromatic bis(methyloxirane ether) wherein the chain extending compound is added in a quantity of ≥1.0 ands ≤2.5 wt % with regard to the total weight of the base polyester to the reaction of the base polyester and the chain extending compound, it is demonstrated that the use of the chain extending compound in such particular quantities may contribute to a desirably high complex viscosity, a good retention of the MVR after a lengthy exposure such as 500 hours, and a good retention of the Izod impact strength.

1. A polymer obtained by reaction of a polyester comprising a quantity of carboxylic terminal groups with a chain extending compound, wherein the chain extending compound is selected from an aromatic bis(oxirane ether) an aromatic bis(methyloxirane ether), or a combination thereof.

2. The polymer according to claim 1, wherein the chain extending compound is selected from 2,2′-methylene-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bis(3-methyl-oxirane), 4,4′-bis(1,2-epoxypropoxy)biphenyl, 2,2′-((1,1′-biphenyl])-4,4′-diylbis(oxy))bisoxirane, 1,4-bis(1,2-epoxypropoxy)benzene, 2,2′-(1,4-phenylenebis(oxy)bisoxirane, 2,2′-((1,1′-binaphthalene)-2,2′-diylbis(oxy))bisoxirane, ((6′-oxiranylmethoxy(2,2′-binaphthalene)-6-yl)oxy)oxirane, 2,2′-(1,6-naphthalenediylbis(oxy))bisoxirane, 2,2′-((1,1′-biphenyl)-4,4′-diylbis(oxy))bis(2-methyl-oxirane), 2,2′-(2,6-naphthalenediylbis(oxy))bis(2-methyl-oxirane), 2,2′-(methylenebis(4,1-phenyleneoxy))bis(2-methyl-oxirane), 2,2′-(1,4-phenylenebis(oxy))bis(2-methyl-oxirane), (2-methyl-4-((oxiranyloxy)methyl)phenoxy)oxirane, (2,6-dimethyl-4-((oxiranyloxy)methyl)phenoxy)oxirane, or a combination thereof.

3. The polymer according to claim 1, wherein the chain extending compound is 2,2′-(1-methylethylidene)-bis(4,1-phenyleneoxy)bisoxirane.

4. The polymer according to claim 1, wherein the chain extending compound is added to the reaction of the polyester and the chain extending compound in a quantity of ≥0.5 and ≤8.0 wt % with regard to the total weight of the polyester and the chain extending compound.

5. The polymer according to claim 1, wherein the polymer comprises units according to formula I: 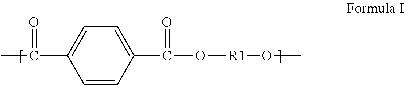
wherein R1 is selected from CH₂—CH₂, CH₂—CH₂—CH₂, or CH₂—CH₂—CH₂—CH₂;
and
≥0.03 mol of units according to formula III: 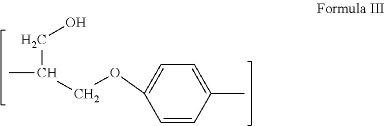
per mol of units according to formula I.

6. The polymer according to claim 1, wherein the reaction takes place in the presence of a catalyst selected from:
an oxide selected from zinc oxide, magnesium oxide, titanium oxide, or antimony trioxide;
a borate selected from zinc borate, calcium borate, sodium tetraphenylborate, tetrabutyl ammonium tetraphenylborate, trioctanol borate or triethanol borate;
a phosphate selected from zinc phosphate, calcium phenyl phosphate, calcium hydroxyapatite, aluminium phosphate, or zinc diethylphosphinate; or
a carboxylate selected from sodium acetate, zinc acetate, magnesium stearate, calcium stearate, sodium stearate or zinc stearate.

7. The polymer according to claim 6 wherein the catalyst is a carboxylate selected from sodium acetate, zinc acetate, magnesium stearate, calcium stearate, sodium stearate or zinc stearate.

8. The polymer according to claim 1, wherein the catalyst is added to the reaction of the polyester and the chain extending compound in a quantity of ≥0.01 and ≤0.25 wt % with regard to the total weight of the polyester and the chain extending compound in the reaction.

9. The polymer according to claim 1, wherein the polyester is selected from poly(ethylene terephthalate), poly(propylene terephthalate), poly(ethylene naphthanoate), or poly(butylene terephthalate).

10. The polymer according to claim 1, wherein the polyester is poly(butylene terephthalate), wherein the poly(butylene terephthalate) has:
a carboxylic end group content as determined in accordance with ASTM D7409-15 of ≥5 and ≤100 mmol/g; and/or
an intrinsic viscosity of ≥0.50 and ≤2.00 dl/g as determined in accordance with ASTM D2857-95 (2007).

11. The polymer according to claim 1, having a complex viscosity as determined via dynamic mechanical spectroscopy (DMS) at 1 rad/s of ≥1200 Pa·s.

12. A polymer composition comprising a polymer according to claim 1, wherein the polymer composition further comprises:
5.0-40.0 wt % of glass fibres; and/or
0.0-10.0 wt % of linear low-density polyethylene having a density of ≥905 and ≤930 kg/m³ as determined in accordance with ISO 1183-1 (2012)
with regard to the total weight of the polymer composition.

13. The polymer composition according to claim 12 wherein the polymer composition comprises ≥50.0 and ≤90.0 wt % of a polymer according to claim 1, with regard to the total weight of the polymer composition.

14. A process for the preparation of a polymer according to claim 1, comprising subjecting the polyester and the chain extender to melt mixing in a melt extruder wherein the temperature in the volume of space in the area between the tip(s) of the extruder screw(s) and the opening(s) for removing the obtained polymer composition is 250-260° C.

15. The process according to claim 14 wherein the residence time of the polyester in the melt extruder is 15-45 seconds.

16. The polymer according to claim 5, wherein the polyester is poly(butylene terephthalate), wherein the poly(butylene terephthalate) has:
a carboxylic end group content as determined in accordance with ASTM D7409-15 of ≥5 and ≤100 mmol/g; and/or
an intrinsic viscosity of ≥0.50 and ≤2.00 dl/g as determined in accordance with ASTM D2857-95 (2007).

17. The polymer according to claim 5, having a complex viscosity as determined via dynamic mechanical spectroscopy (DMS) at 1 rad/s of ≥1200 Pa·s.

18. A polymer composition comprising a polymer according to claim 5, wherein the polymer composition further comprises:
5.0-40.0 wt % of glass fibres; and/or
0.0-10.0 wt % of linear low-density polyethylene having a density of ≥905 and ≤930 kg/m³ as determined in accordance with ISO 1183-1 (2012)
with regard to the total weight of the polymer composition.

19. A polymer, comprising units according to formula I: 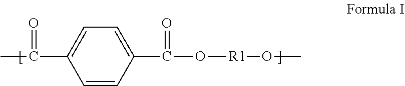
wherein R1 is selected from CH₂—CH₂, CH₂—CH₂—CH₂, CH₂—CH₂—CH₂—CH₂;
and
≥0.03 mol of units according to formula III: 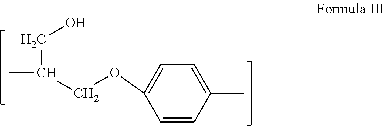
per mol of units according to formula I.
